(19) United States
(12) Patent Application Publication
(10) Pub. No.: US 2012/0217285 A1
(43) Pub. Date: Aug. 30, 2012

(54) SOLDERING JIG

(75) Inventor: Jin Koo Rhee, Seoul (KR)

(73) Assignee: Dongguk University Industry-Academic Cooperation Foundation, Seoul (KR)

(21) Appl. No.: 13/468,652

(22) Filed: May 10, 2012

Related U.S. Application Data
(63) Continuation of application No. PCT/KR10/07297, filed on Oct. 22, 2010.

(30) Foreign Application Priority Data
Nov. 10, 2009 (KR) 10-2009-0108186
Nov. 25, 2009 (KR) 10-2009-0114800

(51) Int. Cl. B23K 3/00

(52) U.S. Cl. 228/44.3

(57) ABSTRACT

A soldering jig is disclosed. The soldering jig in accordance with an embodiment of the present invention includes: a mounting block having a plurality of accommodation holes penetrating from one surface to the other surface thereof, a plurality of soldered objects being accommodated in the plurality of accommodation holes; a first cover block coupled to one surface of the mounting block and having a support part configured to support the plurality of soldered objects accommodated in the plurality of accommodation holes; and a second cover block coupled to the other surface of the mounting block and having a plurality of pressing protrusions protruded to face the plurality of accommodation holes, respectively, to elastically support the plurality of soldered objects. Accordingly, a Gunn diode package that is soldered in a uniform quality can be obtained by maintaining a uniform pressure and heat transfer to the soldered objects in a soldering process.

### CROSS-REFERENCE TO RELATED APPLICATIONS

This application is a continuation of PCT/KR/2010/007297 filed Oct. 22, 2010, which claims the benefit of Korean Patent Application No. 10-2009-0108186, filed with the Korean Intellectual Property Office on Nov. 10, 2009 and Korean Patent Application No. 10-2009-0114800, filed with the Korean Intellectual Property Office on Nov. 25, 2009, the disclosures of which are incorporated herein by reference in entirety.

### BACKGROUND

1. Technical Field

The present invention relates to a soldering jig.

2. Background Art

With an increasing demand for millimeter wave FMCW radar sensors, the performance of the voltage controlled oscillator (VCO), which is an important component of the FMCW radar sensor, has been increasingly improved. Particularly, there have been a large number of studies on Gunn diode, which is an oscillation device of the VCO.

Importance for the production of the Gunn diode for use in the VCO is the package technology, especially for joining the components of the package. The Gunn diode package is typically constituted with a stud, a ceramic ring and a lid, and the stud and the ceramic ring are brazed together.

The lid needs to be joined with the brazed stud and ceramic ring by use of a solder, such as Au—Sn or Ag—Sn, because a joining process such as brazing that is performed in a high temperature cannot be used in order to prevent performance deterioration and damage of the Gunn diode chip. Here, in order to obtain a uniform quality of Gunn diode package, it is important to maintain a uniform pressure between soldered objects during the soldering process.

Moreover, as the soldering process is carried out by melting the solder using an oven or furnace and injecting the solder in between the objects that are to be soldered, it is very important that the heat is uniformly transferred to the objects to be joined with each other. Furthermore, for proper commercialization, it is important that a large number of Gunn diodes are soldered at the same time.

### SUMMARY

An embodiment of the present invention provides a soldering jig that can apply a uniform pressure to a plurality of soldered objects in a soldering process.

Moreover, an embodiment of the present invention provides a soldering jig that can transfer heat uniformly to a plurality of soldered objects.

An aspect of the present invention features a soldering jig, which can include: a mounting block having a plurality of accommodation holes penetrating from one surface to the other surface thereof, a plurality of soldered objects being accommodated in the plurality of accommodation holes; a first cover block coupled to one surface of the mounting block and having a support part configured to support the plurality of soldered objects accommodated in the plurality of accommodation holes; and a second cover block coupled to the other surface of the mounting block and having a plurality of pressing protrusions protruded to face the plurality of accommodation holes, respectively, to elastically support the plurality of soldered objects.

At least one of the mounting block, the first cover block and the second cover block can have a heat transfer groove, which communicates the accommodation holes to an outside, formed therein.

The support part can include a plurality of support protrusions protruded to face the plurality of accommodation holes, respectively.

The plurality of support protrusions can be elastically supported.

At least one of the first cover block and the second cover block can also include a plurality of springs configured to elastically support the plurality of support protrusions or the plurality of pressing protrusions, respectively.

According to an embodiment of the present invention, a Gunn diode package that is soldered in a uniform quality can be obtained by maintaining a uniform pressure and heat transfer to the soldered objects in a soldering process.

Moreover, a plurality of Gunn diode packages can be soldered at the same time.

### BRIEF DESCRIPTION OF THE DRAWINGS

FIG. 1 is a perspective view showing a soldering jig in accordance with an embodiment of the present invention.

FIG. 2 is a cross-sectional view showing the soldering jig in accordance with an embodiment of the present invention.

FIG. 3 is a perspective view showing a mounting block of the soldering jig in accordance with an embodiment of the present invention.

FIG. 4 is a perspective view showing a first cover block of the soldering jig in accordance with an embodiment of the present invention.

FIG. 5 is a perspective view showing a second cover block of the soldering jig in accordance with an embodiment of the present invention.

### DETAILED DESCRIPTION

Hereinafter, an embodiment of the present invention will be described with reference to the accompanying drawings.

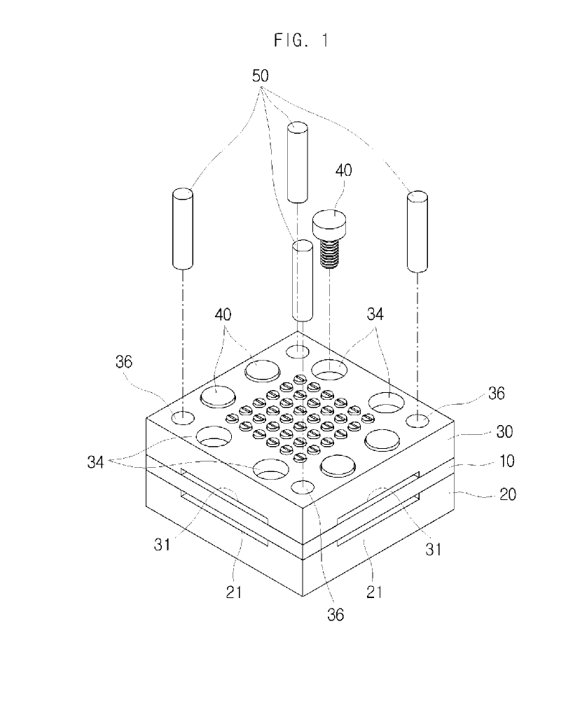

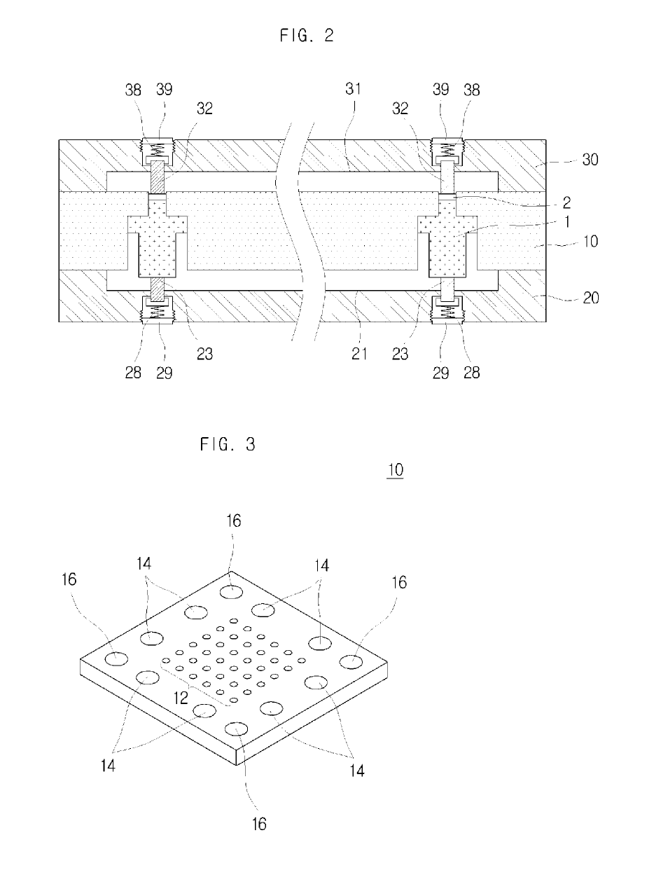

FIG. 1 is a perspective view showing a soldering jig in accordance with an embodiment of the present invention, and FIG. 2 is a cross-sectional view showing the soldering jig in accordance with an embodiment of the present invention.

Referring to FIGS. 1 and 2, the soldering jig includes a mounting block 10, a first cover block 20 and a second cover block 30.

The mounting block 10 is a portion where a plurality of soldered objects 1, 2 are accommodated during a soldering process. Such a mounting block will be described in detail with reference to FIG. 3.

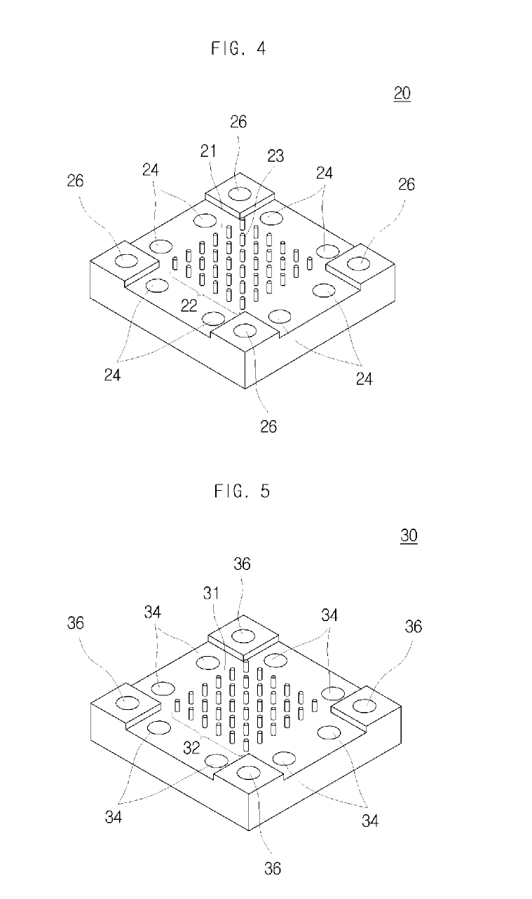

The first cover block 20 supports the plurality of soldered objects 1, 2 on one surface of the mounting block 10 during the soldering process. For this, the first cover block 20 is coupled to the one surface of the mounting block 10 and has a support part 22 that supports the plurality of soldered objects 1, 2 accommodated in a plurality of accommodation holes 12. The first cover block 20 will be described in detail with reference to FIG. 4.

The second cover block 30 elastically supports the plurality of soldered objects 1, 2 on the other surface of the mounting block 10 during the soldering process. For this, the second cover block 30 is coupled to the other surface of the mounting block 10 and has a plurality of pressing protrusions 32 that elastically supports the plurality of soldered objects 1, 2, respectively. The second cover block 30 will be described in detail with reference to FIG. 5.

At least one of the first cover block 20 and the second cover block 30 can be detachably coupled to the mounting block 10. Accordingly, when the soldered objects 1, 2 are mounted to and separated from the mounting block 10, at least one of the first cover block 20 and the second cover block 30 can be removed, thereby opening at least one surface of the mounting block 10 and allowing for easy mounting or separation of the soldered objects 1, 2.

Although it is described in the present embodiment that both the first cover block 20 and the second cover block 30 are formed to be attachable to and detachable from the mounting block 10, the present invention is not restricted to what is described herein, and it is also possible that the first cover block 20 or the second cover block 30 is formed in an integrated fashion with the mounting block 10.

Meanwhile, in order to align the mounting block 10, the first cover block 20 and the second cover block 30 when the soldering jig is assembled, placement holes 16, 26, 36 that align mutual alignment can be formed in the mounting block 10, the first cover block 20 and the second cover block 30, and alignment pins 50 can be inserted in the placement holes 16, 26, 36. In the present embodiment, the placement holes 16, 26, 36 are formed at four corners of the mounting block 10, the first cover block 20 and the second cover block 30.

Then, the aligned soldering jig can be assembled by bolt fastening. In the present embodiment, the mounting block 10 and the second cover block 30 have bolt penetrating holes 14, 34, through which a bolt 40 penetrates, formed therein, and the first cover block 20 has bolt coupling holes 24, to which the bolt 40 is coupled, formed therein. Accordingly, by inserting and fastening the bolt 40 from the second cover block 30, the mounting block 10, the first cover block 20 and the second cover block 30 can be coupled with one another.

FIG. 3 is a perspective view showing a mounting block of the soldering jig in accordance with an embodiment of the present invention.

Referring to FIG. 3, the mounting block 10 has the plurality of accommodation holes 12 formed therein to penetrate from one surface to the other surface thereof. Accordingly, as shown in FIG. 2, the soldered objects 1, 2 can be mounted in each of the accommodation holes 12, making it possible to solder the plurality of soldered objects 1, 2 at once through one soldering process.

The soldering jig of the present embodiment is for use in a soldering process of a Gunn diode package, and an assembly 1 of a stud and a ceramic ring and a lid 2 are faced to each other and mounted in each of the accommodation holes 12 of the mounting block 10 so that the assembly 1 and the lid 2 can be soldered with each other. Solder for use in soldering is interposed between the assembly 1 and the lid 2.

Here, each of the accommodation holes 12 of the mounting block 10 can have a step part, at which the soldered object 1 is arrived, formed therein. Specifically, as shown in FIG. 2, the step part at which the assembly 1 of the stud and the ceramic ring is arrived is formed inside the accommodation hole 12 in such a way that the assembly 1 can be securely supported in between the step part and a support protrusion 23, which will be described later. Accordingly, the lid 2 that is joined to the assembly 1 can be also supported securely in the soldering process.

FIG. 4 is a perspective view showing the first cover block 20 of the soldering jig in accordance with an embodiment of the present invention.

Referring to FIG. 4, the support part 22 of the first cover block 20 has a plurality of support protrusions 23 that are protruded, respectively, to face the plurality of accommodation holes 12 in such a way that the plurality of support protrusions 23 support the plurality of soldered objects 1, 2, respectively. Accordingly, the heat transferred through a heat transfer groove 21, which will be described later, can be evenly transferred to the soldered objects 1, 2 through a space formed in between the support protrusions 23.

Here, as shown in FIG. 2, the support protrusions 23 are elastically supported in such a way that the assembly 1 of the stud and the ceramic ring can be supported with a uniform pressure. Specifically, each of the support protrusions 23 can be supported by a spring 28.

The elastic force of the spring 28 can be controlled by an elasticity control member 29 coupled to the spring 28. Accordingly, a uniform pressure can be applied to the plurality of soldered objects 1, 2 by maintaining a support force of the support protrusions 23 by use of the elasticity control member 29. In the present embodiment, the elastic force of the spring 28 is controlled by setting an initial displacement of the spring 28 through the elasticity control member 29 that is screw-coupled to the first cover block 20.

Moreover, the first cover block 20 can have the heat transfer groove 21, which communicates the accommodation holes 12 to an outside, formed therein. Specifically, in the present embodiment, the heat transfer groove 21 in the shape of a cross is formed on a surface facing one surface of the mounting block 10. Accordingly, the heat emanated from an oven or a furnace can be introduced into the soldering jig through a lateral side of the soldering jig in such a way that the soldered objects 1, 2 mounted in the accommodation hole 12 can be evenly heated. Although the present embodiment describes that the heat transfer groove 21 is formed in the first cover block 20 and the second cover block 30, it is also possible that the heat transfer groove 21 that communicates the accommodation holes 12 to the outside is formed in the mounting block 10 to perform the same function.

FIG. 5 is a perspective view showing the second cover block 30 of the soldering jig in accordance with an embodiment of the present invention.

As shown in FIG. 5, the second cover block 30 has the plurality of pressing protrusions 32 that are protruded to face the plurality of accommodation holes 12, respectively. Accordingly, the heat transferred through a heat transfer groove 31, which will be described later, can be evenly transferred to the soldered objects 1, 2 through a space formed in between the pressing protrusions 32.

Since each of the pressing protrusions 32 is elastically supported, the lid 2, which is the soldering object, can be pressed with a uniform pressure. Specifically, as shown in FIG. 2, each of the pressing protrusions 32 can be supported by the spring 38.

The elastic force of the spring 38 can be controlled by an elasticity control member 39 coupled to the spring 38. Accordingly, a uniform pressure can be applied to the plurality of soldered objects 1, 2 by maintaining a pressure of the pressing protrusions 32 by use of the elasticity control member 39. In the present embodiment, the elastic force of the spring 38 is controlled by setting an initial displacement of the spring 38 through the elasticity control member 39 that is screw-coupled to the second cover block 30.

Moreover, the second cover block 30 can have the heat transfer groove 31, which communicates the accommodation holes 12 to the outside, formed therein. Specifically, in the present embodiment, the heat transfer groove 31 in the shape of a cross is formed on a surface facing the other surface of the mounting block 10. Accordingly, the heat emanated from the oven or the furnace can be introduced into the soldering jig through a lateral side of the soldering jig in such a way that the soldered objects 1, 2 mounted in the accommodation hole 12 can be evenly heated.

Although the present invention has been described through a certain embodiment, it shall be appreciated that there can be a variety of modifications and permutations of the present invention by a person of ordinary skill in the art to which the present invention pertains without departing from the technical ideas and scope of the present invention that shall be defined by the claims appended below.

What is claimed is:

1. A soldering jig, comprising:
a mounting block having a plurality of accommodation holes penetrating from one surface to the other surface thereof, a plurality of soldered objects being accommodated in the plurality of accommodation holes;
a first cover block coupled to one surface of the mounting block and having a support part configured to support the plurality of soldered objects accommodated in the plurality of accommodation holes; and
a second cover block coupled to the other surface of the mounting block and having a plurality of pressing protrusions protruded to face the plurality of accommodation holes, respectively, to elastically support the plurality of soldered objects.

2. The soldering jig of claim 1, wherein at least one of the mounting block, the first cover block and the second cover block has a heat transfer groove formed therein, the heat transfer groove configured to communicate the accommodation holes to an outside.

3. The soldering jig of claim 1, wherein the support part comprises a plurality of support protrusions protruded to face the plurality of accommodation holes, respectively.

4. The soldering jig of claim 3, wherein the plurality of support protrusions are elastically supported.

5. The soldering jig of claim 4, wherein at least one of the first cover block and the second cover block further comprises a plurality of springs configured to elastically support the plurality of support protrusions or the plurality of pressing protrusions, respectively.
